(19) United States
(12) Patent Application Publication
(10) Pub. No.: US 2008/0083516 A1
(43) Pub. Date: Apr. 10, 2008

(54) Magnetic window

(76) Inventor: Nicholas J. Aravanis, (US)

Correspondence Address: Stephen R. Greiner, Esquire;GREINER LAW OFFICES, P.C., Suite 110, 6701 Democracy Blvd,, Bethesda, MD, 20817, US

(21) Appl. No.: 11/517,482

(22) Filed: Sep. 8, 2006

(51) Int. Cl. E06B 3/12

(52) U.S. Cl. 160/216

(57) ABSTRACT

A magnetic window including slidably engaged female and male portions. The female portion has a first transparent panel and a pair of rearwardly projecting fins being affixed, respectively, to the top and bottom of the first transparent panel so as to have a free end remote from the first transparent panel. Each of the fins is provided at its free end with a lip. Each lip projects toward the other so as to define a guideway between itself and the first transparent panel. A first forwardly projecting retaining flange is affixed to one of the opposed sides of the first transparent panel. A first magnetic strip is affixed to the first forwardly projecting retaining flange. The male portion, however, has a second transparent panel with its top positioned within one guideway in the female portion and has its bottom positioned within another guideway in the female portion. A second forwardly projecting retaining flange is affixed to one of the second opposed sides of the second transparent panel. A second magnetic strip is affixed to the second forwardly projecting retaining flange.

### FIELD OF THE INVENTION

The present invention relates generally to movable or removable closures and, more particularly, to facially opposed primary and auxiliary closures for a common opening.

### BACKGROUND OF THE INVENTION

It is not unusual for technicians to perform repair work on a furnace blower only to be called back within hours to fix the problem that the original repair was meant to solve. Often the faulty repair can be traced to a technician testing the results of his repair with one or more furnace doors open. Leaving the doors open permits the technician to visually monitor the goings-on within the furnace and allows him to immediately handle glitches if they develop. In short, a “doors open” approach eliminates guesswork and saves the technician time. Nonetheless, because air flows freely into the blower through the open service port, a “doors open” approach cannot place the blower fully under load so as to test it under normal operating conditions.

Only with the service port of a furnace being closed can the drawdown pressures of normal operation be duplicated. Unfortunately, furnace doors are opaque and time-consuming to install. So, because furnace technicians are known to lack x-ray vision, closing the service port of a furnace deprives a technician of both visual clues and time required to solve a problem presented by a faulty furnace.

### SUMMARY OF THE INVENTION

In light of the problems associated with the known methods and apparatus used to diagnose and fix broken furnaces, it is a principal object of the invention to provide a transparent window for temporarily closing the service port of a furnace. The window is variable in size, capable of being telescoped to fit furnace service ports of different widths. Furthermore, the window is magnetically secured to the furnace making such easy to detach when no longer needed for diagnostic purposes.

It is another object of the invention to provide a magnetic window of the type described that is easy to use and can be deployed with minimal instruction and without resort to any tools. The window is intuitive to deploy.

It is an object of the invention to provide improved features and arrangements thereof in a magnetic window for the purposes described that is lightweight in construction, inexpensive to manufacture, and dependable in use.

Briefly, the magnetic window in accordance with this invention achieves the intended objects by featuring male and female portions that are slidably engaged with one another. The female portion has a pair of guideways, respectively positioned at its top and bottom, within which the male portion slides to selectively increase the length of the window to fit furnace service ports of various sizes. The outer side of each of the female and male portions is provided with a flange for a tight fit against the sides of a furnace once its service door is removed. Magnetic strips are provided on the flanges for releasably holding the window over the service port. A slot in each of the flanges permits the passage of electrical cables to diagnostic equipment placed within the furnace.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a front view of a magnetic window in accordance with the present invention shown mounted on a furnace.

FIG. 2 is a perspective view of the magnetic window of FIG. 1 with its male and female portions disengaged to reveal details thereof.

FIG. 3 is a perspective view of the magnetic window with its male and female portions being slidably engaged with one another.

FIG. 4 is a top view of the magnetic window.

FIG. 5 is a side view of the magnetic window.

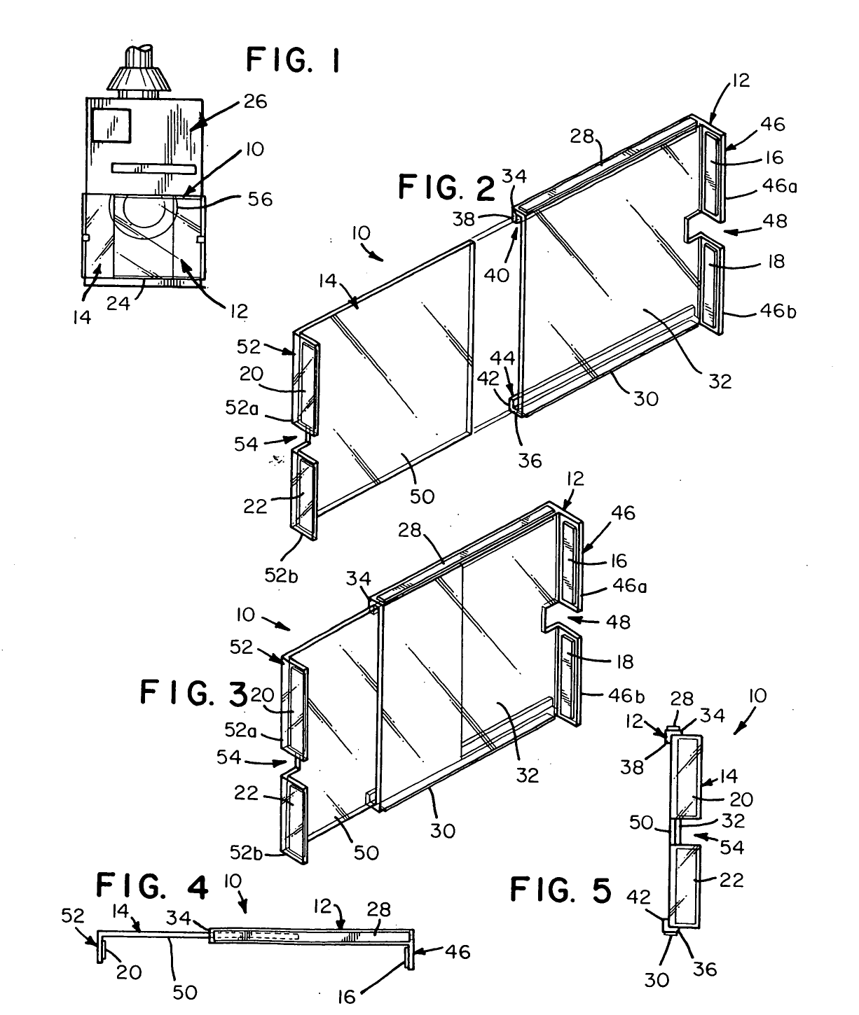

Similar reference characters denote corresponding features consistently throughout the accompanying drawings.

### DETAILED DESCRIPTION OF THE PREFERRED EMBODIMENT

Referring now to the FIGS., a magnetic window in accordance with the present invention is shown at 10. Window 10 includes a female portion 12 and a male portion 14 that are slidably engaged with one another to close openings of different sizes. Each of portions 12 and 14 is provided with a pair of magnetic strips 16 and 18, and 20 and 22, respectively, for securing window 10 to the sides of a service port 24 of a household furnace 26. Portion 12 can have an additional pair of magnetic strips 28 and 30 for securing window 10 to the top and bottom of port 24.

Female portion 12 includes a transparent panel 32 of rectangular outline having a pair of rearwardly projecting fins 34 and 36 being affixed, respectively, to the top and bottom thereof. Fin 34 is provided at its free end with a downwardly projecting lip 38 that defines a guideway 40 between itself and panel 32 adjacent the top of panel 32. Fin 36, however, is provided with an upwardly projecting lip 42 at its free end that defines a guideway 44 adjacent the bottom of panel 32.

Transparent panel 32 has a retaining flange 46 that is affixed to one side thereof. As shown, flange 46 projects forwardly from panel 32 and extends from the top of panel 32 to the bottom of panel 32. Flange 46 is bifurcated by a slot 48 into an upper part 46a and a lower part 46b. Slot 48 extends from the free end of flange 46 past the inner end thereof, where flange 46 is affixed to panel 32, and into panel 32 a short distance.

Magnetic strips 16, 18, 28 and 30 releasably secure female portion 12 to furnace 26. A pair of magnetic strips 16 and 18 is affixed by means of a suitable adhesive to flange 46. Strip 16 is affixed to upper part 46a of flange 46 and extends from the top to the bottom of upper part 46a. Strip 18, however, is affixed to lower part 46b of flange 46 and extends from the top to the bottom of lower part 46b. Strip 28 is adhesively affixed to the top of fin 34 and strip 30 is affixed to the bottom of fin 36.

Male portion 14 includes a transparent panel 50 of rectangular outline. Panel 50 has substantially the same width as panel 32 and has a height that is somewhat less than the distance between fins 34 and 36 of female portion 12. Also, the thickness of panel 50 is slightly less than the distance between lip 38 or 42 and panel 32. Thus, panel 50 can be slidably engaged, at its top and bottom, with guideways 40 and 44, and portions 12 and 14 can be nested together

Transparent panel 50 has a retaining flange 52 that is affixed to one side thereof. Flange 52 projects forwardly from panel 50 and extends from the top of panel 50 to the bottom of panel 50. Flange 52 is bifurcated by a slot 54 into an upper part 52a and a lower part 52b. Slot 54 extends from the free end of flange 52 past the inner end thereof, where flange 52 is affixed to panel 50, and into panel 50 a short distance.

A pair of magnetic strips 20 and 22 is affixed by an adhesive to flange 52. Strip 20 is affixed to upper part 52a of flange 52 and extends from the top to the bottom of upper part 52a. Strip 22 is affixed to lower part 52b of flange 52 and extends from the top to the bottom of lower part 52b.

The use of magnetic window 10 is straightforward. First, the door (not shown) normally covering service port 24 of furnace 26 is removed to access the furnace blower 56. Next, diagnostic probes (not shown) like those associated with voltage meters and temperature or pressure gauges, are positioned within furnace 26 and, if necessary, connected to blower 56. Then, with portions 12 and 14 facing forwardly toward furnace 26, panels 32 and 50 are spread from one another so that flanges 46 and 52 can be engaged with the opposite sides of furnace 26 adjacent service port 24. Now, any cables (not shown) extending from the diagnostic probes are routed through either of slots 48 and 54. Finally, panels 32 and 50 are moved forwardly to close service port 24 and magnetic strips 16, 18, 20 and 22 are engaged with the opposite sides of furnace 26 to connect window 10 to furnace. Magnetic strips 28 and 30 can be, depending upon the configuration of furnace 26, similarly engaged to connect window 10 at its top and bottom to furnace 26.

With window 10 closing service port 24, a technician can view the workings of blower 56 with blower 56 being energized and while under normal loading conditions. Such conditions, of course, are not present when service port 24 is open to the atmosphere. Should any deficiencies in the operation of blower 56 be detected visually or by means of diagnostic probes, work to correct such deficiencies can be initiated immediately simply by de-energizing blower 56 and removing window 10 by reversing the steps outlined hereinabove for access to blower 56.

When the use of window 10 is concluded, portions 12 and 14 can be fully nested together for compact transport and storage. Window 10, of course, is ready for immediate reuse.

While window 10 has been described with a high degree of particularity, it will be appreciated by those skilled in the art that modifications may be made to it. For example, the transparent panel 32, fins 34 and 36, lips 38 and 42, and flange 46 of female portion 12 are preferably formed as an integral unit from a stiff plastic like Plexiglas; however, portion 12 can be assembled from separate components made from materials that, by way of example, might include: glass, plastic, metal or wood. Also, panel 50 and flange 52 of male portion 14, preferably integrally constructed of Plexiglas, could be similarly constructed from a composite of materials as a matter of design choice on the part of the manufacturer. Therefore, it is to be understood that the present invention is not limited to the sole window embodiment described above, but encompasses any and all embodiments within the scope of the following claims.

I claim:

1. A magnetic window, comprising:
a female portion including:
a first transparent panel having a top, bottom, and first opposed sides;
a pair of rearwardly projecting fins being affixed, respectively, to the top and bottom of said first transparent panel so as to have a free end remote from said first transparent panel, each of said fins being provided at its free end with a lip, each said lip projecting toward the other so as to define a guideway between itself and said first transparent panel; and,
a first forwardly projecting retaining flange being affixed to one of said first opposed sides of said first transparent panel;
a first magnetic strip being affixed to said first forwardly projecting retaining flange; and,
a male portion being slidably engaged with said female portion, said male portion including:
a second transparent panel having a top positioned within one said guideway in said female portion and having a bottom positioned within another said guideway in said female portion, and said second transparent panel also having second opposed sides;
a second forwardly projecting retaining flange being affixed to one of said second opposed sides of said second transparent panel; and,
a second magnetic strip being affixed to said second forwardly projecting retaining flange.

2. The magnetic window according to claim 1 wherein said first forwardly projecting retaining flange is bifurcated by a first slot that extends into said first transparent panel.

3. The magnetic window according to claim 1 wherein said second forwardly projecting retaining flange is bifurcated by a second slot that extends into said second transparent panel.

4. The magnetic window according to claim 1 wherein said female portion further includes a pair of third magnetic strips, each one of said third magnetic strips being affixed to a respective one of said rearwardly projecting fins.
